(19) United States
(12) Patent Application Publication
(10) Pub. No.: US 2019/0178267 A1
(43) Pub. Date: Jun. 13, 2019

(54) ASSEMBLY FOR FILLING A GAS TANK

(71) Applicant: Andreas Stihl AG & Co. KG, Waiblingen (DE)

(72) Inventors: Georg Heinzelmann, Winnenden (DE); Malte Hartmann, Hong Kong (CN); Manuel Dangelmeier, Wernau (DE)

(21) Appl. No.: 16/215,397

(22) Filed: Dec. 10, 2018

(30) Foreign Application Priority Data
Dec. 8, 2017 (DE) 10 2017 011 344.0

(51) Int. Cl. F15B 21/00; F17C 5/02

(52) U.S. Cl. CPC F15B 21/005; F17C 5/02; F17C 2227/0135; F17C 2250/0413; F17C 2205/0332

(57) ABSTRACT

An assembly is for filling a gas tank for a combustion engine from a gas-filled storage bottle via a filling device arranged between the tank and the storage bottle. The tank has at least one fill valve for liquefied gas, a pressure relief valve for gas in the gaseous state, and an extraction valve for liquefied gas. The filling device has a gas connection for the storage bottle and has a fill connection for the fill valve. For filling the tank, the fill valve is connected via the filling device to the storage bottle, such that, when the fill valve is open, liquefied gas flows from the storage bottle via the fill valve into the tank. During the inflow of liquefied gas, the pressure relief valve of the tank is at least intermittently open. A filling level gauge is provided for indicating a predefined filling level in the tank.

### CROSS REFERENCE TO RELATED APPLICATION

This application claims priority of German patent application no. 10 2017 011 344.0, filed Dec. 8, 2017, the entire content of which is incorporated herein by reference.

### FIELD OF THE INVENTION

The invention relates to an assembly for filling a gas tank for a gas-powered combustion engine.

### BACKGROUND OF THE INVENTION

U.S. Pat. No. 8,807,240 B2 has disclosed a handheld work apparatus which, as an operating fluid tank, has an exchangeable gas cartridge. The gas cartridge is provided for being inserted upside down into a receptacle on the housing of the work apparatus. When the gas cartridge has been emptied, it must be exchanged for a new gas cartridge. For a relatively long period of working operation, the user must therefore keep a stock of a corresponding number of gas cartridges. Empty gas cartridges are recycled or are refilled at other locations with suitable filling plants.

### SUMMARY OF THE INVENTION

It is an object of the invention to provide an assembly for filling a gas tank for a gas-powered combustion engine, which assembly is easy to operate and permits rapid on-site refilling of a gas tank.

This object can, for example, be achieved via an assembly for filling a gas tank for a gas-powered combustion engine. The assembly includes: a gas-filled storage bottle; the gas tank; a filling device arranged between the gas tank and the storage bottle; the gas tank having at least one fill valve, a pressure relief valve for gas in the gaseous state, and an extraction valve for liquefied gas; the filling device having a gas connection for the storage bottle and a fill connection for the fill valve; the fill valve being connected to the storage bottle via the filling device; wherein, when the fill valve is open, liquefied gas flows from the storage bottle into the gas tank via the fill valve and, during the inflow of liquefied gas, the pressure relief valve of the gas tank is configured to at least intermittently open; and, a filling level gauge configured to indicate a predefined filling level of the gas tank.

Between the gas tank for filling and a storage bottle, there is arranged a filling device which has a gas connection for the storage bottle and a fill connection for a fill valve of the gas tank. The gas tank has not only the fill valve for liquefied gas but also a pressure relief valve for gas in the gaseous state and an extraction valve for liquefied gas. The fill connection of the filling device is connected to the fill valve of the gas tank. During the inflow of liquefied gas through the fill valve into the gas tank, the pressure relief valve of the gas tank is at least intermittently kept open. The storage bottle is situated geodetically higher than the gas tank, such that the liquefied gas can flow unpressurized from the storage bottle into the gas tank. Via the pressure relief valve, the empty area of the gas tank is kept at a low pressure level, such that the liquefied gas flows in without disruption. A predefined filling level of the gas tank is indicated via a filling level gauge, such that, when the predefined filling level is reached, the user can close the bottle valve and end the filling process.

In an embodiment, the filling level gauge is in the form of a float which, when the predefined filling level in the gas tank is reached, closes at least the fill valve. The fill process thus ends automatically without the need for the user to intervene. It is expedient if, when the predefined filling level is reached, the float closes not only the fill valve but also the pressure relief valve.

A simple embodiment of a filling level gauge is formed by a monitoring pipe. That opening of the monitoring pipe which is situated in the tank lies at the height of the predefined maximum filling level. When the latter has been reached, liquefied gas phase enters the monitoring pipe and flows out. The user thus recognizes that the predefined maximum filling level has been reached, and can close the bottle valve.

To identify the attainment of a predefined filling level regardless of position, provision is made for the filling level gauge to be in the form of a monitoring snorkel which floats on the liquid phase of the gas introduced into the tank. In the gas tank, there is provided a filling cage, the cage volume of which is smaller than the predefined filling volume of the gas tank. The monitoring snorkel is situated within the filling cage, which is permeable to liquid. If the filling level in the gas tank rises, the monitoring snorkel floats on the liquid level until it abuts against the filling cage. The monitoring snorkel remains positionally fixed, while the filling level rises further. The monitoring snorkel is thus submerged by the liquid phase of the gas, such that liquefied gas emerges via the monitoring snorkel. Owing to the emergence of liquefied gas phase, the user can recognize that the predefined filling level has been reached, and can close the bottle valve.

In an embodiment, the filling cage is arranged in the gas tank with a distance on all sides. Here, the filling cage is configured such that, irrespective of the situation of the gas tank, the monitoring snorkel is always submerged by liquefied gas phase when the predefined maximum filling level has been reached. It is thus ensured that—irrespective of the situation of the gas tank during the filling process—a residual volume of the gas tank remains free from liquefied gas phase.

The monitoring pipe or the monitoring snorkel is expediently connected to the pressure relief valve of the gas tank. In an embodiment, provision is made for the pressure relief valve to be connected to a pressure reducer, which reduces the pressure of the outflowing gas in the gaseous state.

In an embodiment, provision is made for the filling device to be formed with a pump. The pump is in particular in the form of a membrane pump. To ensure unpressurized pumping, provision is made for the pressure connection of the pump and the suction connection of the pump to be connected to one another via a pressure equalization valve. Unpressurized conveyance of liquefied gas is thus achieved.

In an embodiment, the pump is equipped with a magnetically driven pump element, at least one drive magnet of the pump element being arranged outside the closed pump housing. The pump housing thus has no passages, which have to be sealed, for moving parts.

The drive magnet is situated in a drive plane and is provided for being moved relative to the pump element by a movement drive. The attracting or repelling magnetic forces move the pump element up and down as soon as the drive magnet is moved in the drive plane by the movement drive. To realize good conveying performance, provision is made whereby, above the pump element, multiple drive magnets are arranged on a circular path. A large stroke is achieved if the multiple drive magnets have alternating polarity. The drive magnets which follow one another on a circular path preferably each have different polarity.

The gas tank is advantageously mounted on a gas-powered combustion engine and provided so as to enable the outlet of the pressure relief valve to open into an intake channel of the combustion engine.

The gas-powered combustion engine is preferably provided as a drive engine in a handheld work apparatus, the fillable gas tank being fixedly mounted on the work apparatus as an operating fluid tank fixed to the apparatus.

Further advantageous embodiments are realized through any desired combination of the stated features and of the described embodiments.

### BRIEF DESCRIPTION OF THE DRAWINGS

The invention will now be described with reference to the drawings wherein:

FIG. 1 shows, in a schematic side view, a handheld work apparatus with a gas tank, based on the example of a motorized chainsaw;

FIG. 2 shows, in a schematic side view, a handheld work apparatus with a gas tank, based on the example of a blower apparatus;

FIG. 3 shows a schematic partial view of the gas tank of a work apparatus as an operating fluid tank on a combustion engine;

FIG. 4 is a schematic illustration regarding the feed of liquefied gas to a mixture formation unit of a combustion engine;

FIG. 5 is a schematic illustration of an assembly for filling a gas tank;

FIG. 6 is a schematic illustration of a gas tank with a monitoring snorkel within a filling cage;

FIG. 7 is a schematic illustration as per FIG. 6 with a gas tank in an altered situation;

FIG. 8 is an illustration as per FIG. 6 with a gas tank in an altered situation;

FIG. 9 shows an assembly for filling a gas tank with a pump;

FIG. 10 is a diagrammatic illustration of a pump with a hand crank; and,

FIG. 11 shows a section through the pump as per FIG. 10.

### DESCRIPTION OF THE PREFERRED EMBODIMENTS OF THE INVENTION

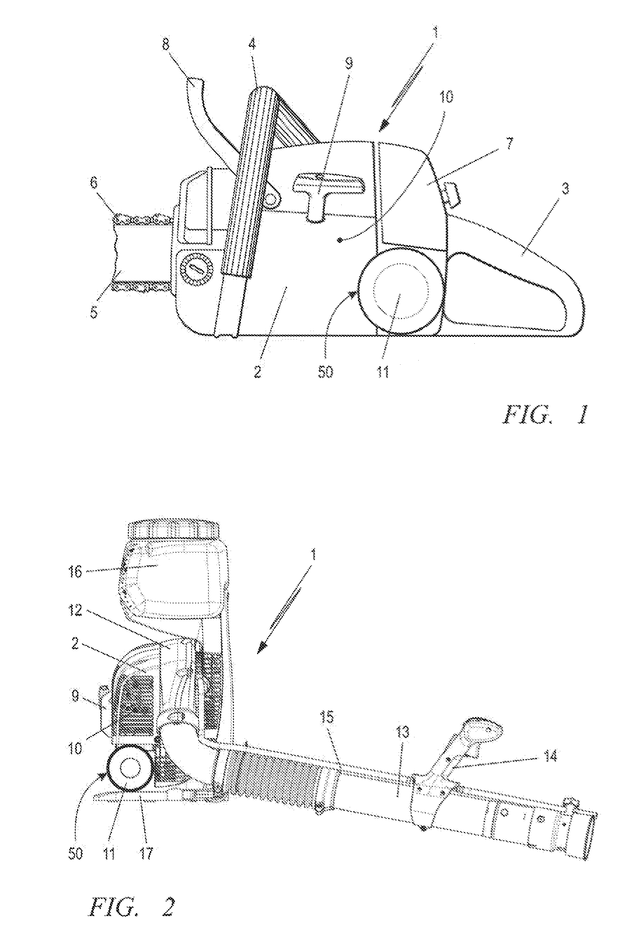

FIG. 1 shows a handheld work apparatus 1 based on the example of a motorized chainsaw. The work apparatus 1 has a housing 2 which has a rear handle 3 and an upper bale handle 4. The bale handle extends from one longitudinal side of the housing 2 to the other longitudinal side of the motorized chainsaw. The handle 3 extends in a longitudinal direction of the work apparatus. A front guide bar 5 also extends in the longitudinal direction of the work apparatus, which guide bar is provided on the front end of the housing 2. A saw chain 6 circulates on the guide bar 5, which saw chain is driven, via a sprocket which is not illustrated, by a combustion engine 10 provided in the housing 2. The combustion engine 10 is illustrated physically in FIGS. 3 and 11. Combustion engine 10 is operated with liquefied gas from a gas tank 11 provided in particular as an operating fluid tank 50. In the embodiment as per FIG. 1, the gas tank 11 as operating fluid tank 50 is situated in the housing 2 of the work apparatus 1 below an air filter 7 in the region of the rear handle 3.

The operation of the saw chain 6 is controlled by a safety brake device. An actuating bracket 8 which is arranged between the saw chain 6 and the upper bale handle 4 serves as an actuating element of the safety brake device.

The combustion engine 10 is started via a pull-rope starter 9. A spring-type starter, an electrical starter or similar starting device may also be provided as starting device.

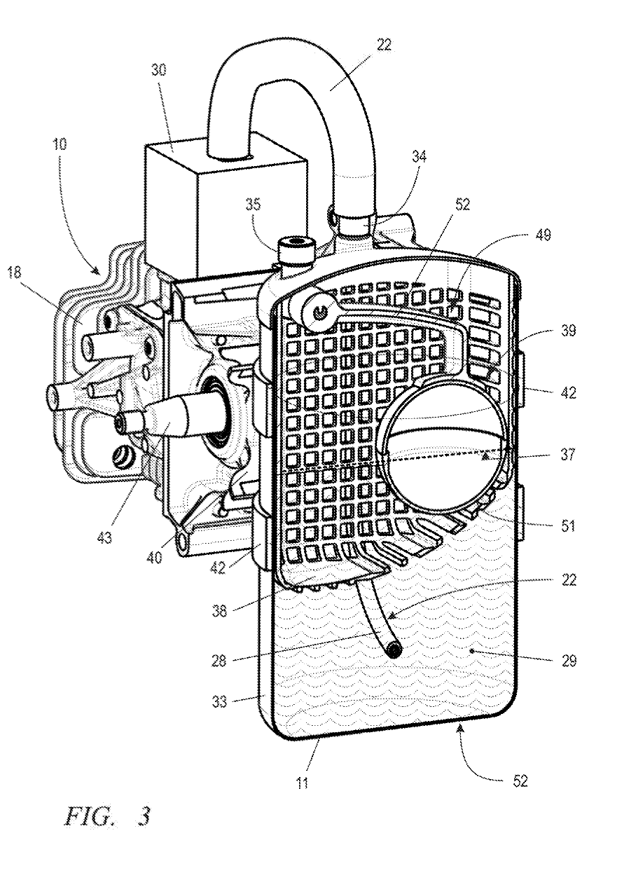

FIG. 2 illustrates a work apparatus 1 based on the example of a backpack-type blower apparatus. The combustion engine 10 is arranged in the housing 2 of the blower apparatus. The combustion engine 10 drives a blower impeller which is arranged in a blower housing 12. The blower housing 12 opens into a blower tube 13, which is provided for being operated via a handle 14.

A spray fluid is fed via a line 15 to the blowing air stream emerging from the blowing tube 13, which spray fluid is stored in a spray fluid tank 16.

Below the combustion engine 10, a gas tank 11 as operating fluid tank 50 is situated between the carrier frame 17 of the backpack-type blower apparatus and the housing 2 of the drive. Liquefied gas as operating fluid is fed from the gas tank 11 to the combustion engine 10.

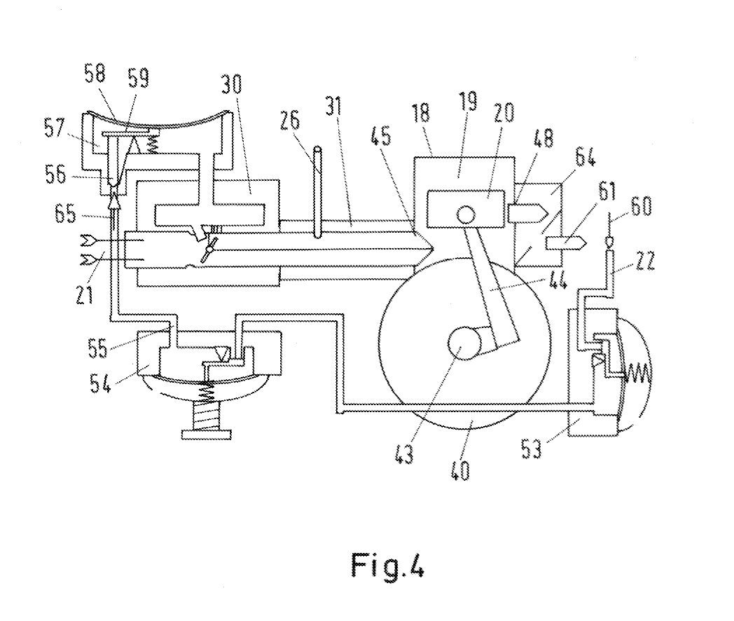

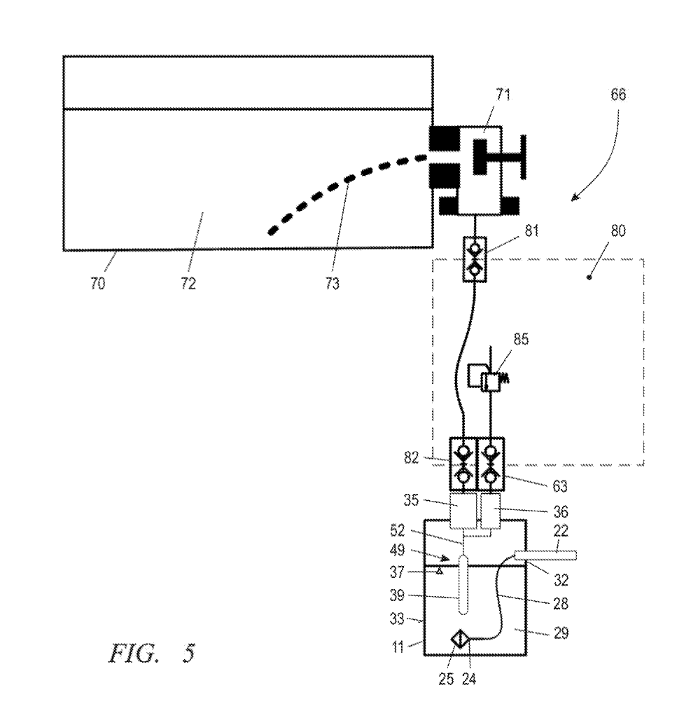

As shown in FIGS. 3 and 4, the gas-powered combustion engine 10 has a cylinder 18 with a combustion chamber 19, which is delimited by a piston 20. For the feed of combustion air 21, an intake channel 31 is formed, expediently on a mixture formation unit 30. A gas 23 is fed via a supply line 22 to the mixture formation unit 30. The gas 23 is advantageously fed in the liquid phase. The supply line 22 in the gas tank 11 is preferably in the form of an elastic hose 28, the end of which has an opening 24. The liquefied gas 23 enters the supply line 22 from the gas tank 11 at the opening 24. As shown for example in FIG. 5, the opening 24 is expediently formed as a suction housing 25. A weight that is preferably provided at the opening 24 ensures that the opening 24 is situated in the liquefied phase of the stored gas 29 in every situation of the gas tank 11. The elastic hose 28 extends from the opening 24 in the liquefied gas phase to a pass through 32 in the tank wall 33. In the pass through 32, there is preferably provided an extraction valve 34 which permits the extraction of the stored, liquefied gas 29 from the gas tank 11.

As shown in FIG. 3, in the embodiment illustrated, the gas tank 11 is fixed to the crank case 40 of the combustion engine 10. For this purpose, the crank case 40 expediently has at least one, preferably two, carrying clamps 41, 42, which may in particular be formed integrally with the crank case 40. The cylinder 18 is fixed to the crank case 40, wherein, in the crank case 40, there is mounted a crank shaft 43, which is connected via a connecting rod 44 to the piston 20.

As shown in FIG. 4, the combustion engine 10 is a piston-ported combustion engine, in particular a two-stroke engine. The intake 45, connected to the mixture formation unit 30, of the combustion engine 10 opens into the crank case 40. The air/gas mixture entering the crank case 40 via the intake 45 is, as the piston 20 travels downward, compressed and forced via flow transfer channels into the combustion chamber 19 of the cylinder 18. As the piston 20 travels upward, the mixture in the combustion chamber 19 is compressed and, in the region of the top dead center of the stroke movement, is ignited by an ignition device (not illustrated in any more detail). The combustion pressure drives the piston 20 downward again. Via an exhaust gas outlet 48, the exhaust gases 61 are discharged via an exhaust muffler 64.

As shown in FIG. 4, the liquefied gas 23 extracted from the gas tank 11 is fed in the arrow direction 60 to an evaporator 53. For temperature equalization, the evaporator 53 is expediently situated in the spatial region of a heat source, for example in the spatial region of the cylinder 18, of the exhaust muffler 64, or is flowed around by the discharged exhaust gases 61. The evaporator 53 ensures that the liquefied gas 23 fed in the arrow direction 60 in the liquefied phase transitions into the gaseous phase. Connected downstream of the evaporator 53 is a pressure reducer 54 for the gaseous phase of the gas. The outlet 55 of the pressure reducer 54 opens via a pressure-controlled control valve 56 into the control chamber 57 of a carburetor, in particular a membrane-type carburetor. The control chamber 57 is delimited by a flexible membrane 58. If gas flows out of the control chamber 57 into the mixture formation unit 30, the pressure in the control chamber 57 will decrease, and the membrane 58 will protrude into the control chamber 57, as illustrated at the top left in FIG. 4. Via a lever assembly 59, the membrane 58 opens the control valve 56, such that gas 65 in the gaseous phase can flow from the pressure reducer 54 in the arrow direction 75 into the mixture formation unit 30.

The gas tank illustrated in FIG. 3 has not only the extraction valve 34 but also a fill valve 35 and expediently a pressure relief valve 36, which is shown in FIG. 5. Arranged within the gas tank 11 is a protective cage 38 in which there is arranged an in particular mechanical filling level gauge 49. The filling level gauge 49 is expediently configured as a float 39 which includes a hollow body 51 which floats on the liquid level of the filling level 37. A predefined filling level 37 of the gas tank 11 can be indicated via the filling level gauge 49. In an advantageous embodiment of the construction, provision is made whereby the float 39, via a control lever 52, controls at least the fill valve 35. If the filling level 37 in the gas tank 11 reaches a predefined height, then at least the fill valve 35 is closed via the control lever 52. It may be expedient if, alternatively to the fill valve 35 or simultaneously with the fill valve 35, the pressure relief valve 36 is closed via the float 39, as illustrated via dashed lines in FIG. 5.

The fill valve 35 and the pressure relief valve 36 open into the gas tank 11 within the protective cage 38. The movable float 39 and its control lever 52 are likewise provided in the protective cage 38. It is thereby ensured that the elastic hose 28, which is movable in terms of its situation in the gas tank 11, does not impair the mechanism of the filling level gauge 49, or the float 39 thereof. The elastic, flexible hose 28 is situated permanently outside the protective cage 38.

In a first embodiment of the assembly 66 for filling a gas tank 11, provision is made for a storage bottle 70 to be connected via a filling device 80 to the gas tank 11. The storage bottle 70 in this case lies higher, in terms of its situation, than the gas tank 11.

The filling device 80 has a gas connection 81 for the storage bottle 70 and has a fill connection 82 for the fill valve 35. The gas tank 11 is connected by the fill connection 82 and the fill valve 35 to the filling device 80. Furthermore, a pressure relief valve 36 of the gas tank 11 is connected via a discharge connection 63. The discharge connection 63 is connected—preferably via a pressure reducer 85—to the atmosphere.

If the bottle valve 71 is connected to the gas connection of the filling device 80 and the bottle valve 71 is opened, then, owing to the higher situation of the storage bottle 70, liquefied gas flows via the extraction hose 73 thereof via the bottle valve 71, the gas connection 81, the fill connection 82 and the fill valve 35 into the gas tank 11, which is situated at a lower height. During the inflow of the liquefied gas 72 from the storage bottle into the gas tank 11, the pressure relief valve 36 of the gas tank 11 is—at least intermittently—open. Via the discharge connection 63 of the filling device 80, the pressure relief valve 36 is connected to the pressure reducer 85. Gas—in the gaseous state—flowing out via the pressure relief valve 36 and the discharge connection 63 is released via the pressure reducer 85 into the surroundings.

To monitor the amount of liquefied gas 29 introduced into the gas tank 11, a filling level gauge 49 is provided, which signals the present filling state 37 of the gas tank 11. This may be realized visually or acoustically or recognized via the change in the phase of the outflowing gas.

As shown in FIG. 5, the filling level gauge 49 is in the form of a float 39 which, when a predefined filling level 37 is reached, closes at least the fill valve 35. For this purpose, the float 39 is connected via a control lever 52 to the fill valve 35. It may be expedient if, when the predefined filling level 37 is reached, the float 39 closes not only the fill valve 35 but also the pressure relief valve 36. This is indicated by dashed lines in FIG. 5.

A simple embodiment of a filling level gauge is a monitoring pipe 95, as illustrated in FIG. 9. In a predetermined situation of the gas tank 11, the monitoring pipe 95 detects the predefined, in particular maximum admissible filling level 37. When the filling level 37 is reached, liquefied gas phase will emerge from the monitoring pipe 95, such that a user can recognize that the predefined filling level 37 has been reached. The gas expediently escapes from the monitoring pipe 95 via a pressure relief valve 36.

It is preferable if the pressure relief valve 36 or the pressure reduction valve 85 in the embodiment as per FIG. 5 or 9 opens into the atmosphere. It may be expedient for the outlet 26 of the pressure relief valve 36 or the pressure reduction valve 85 to open into the intake channel 31 of the combustion engine 10.

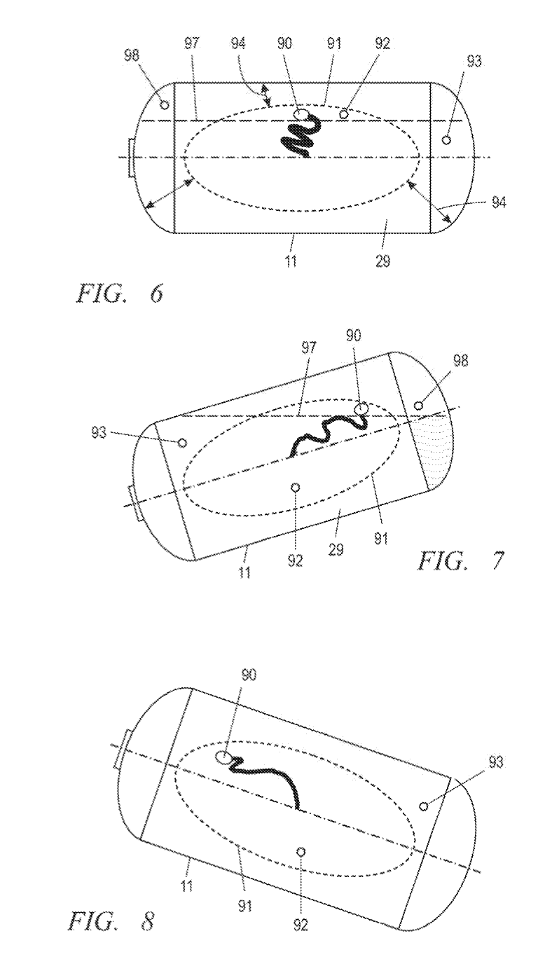

In a preferred embodiment, the filling level gauge is in the form of a monitoring snorkel 90 as illustrated in FIGS. 6 to 8. The monitoring snorkel 90 floats on the liquid phase of the gas 29 introduced into the gas tank. The monitoring snorkel 90 is provided within a filling cage 91, which is situated within the gas tank 11 with a distance 94 on all sides. The cage volume 92 of the filling cage 91 is smaller than a maximum filling volume 93 of the gas tank 11.

If—for example in the tank situation in FIG. 6—the gas tank 11 is filled, the monitoring snorkel 90 will float on the liquid level 97 of the liquefied gas 29. The filling cage 91 is permeable to the liquefied gas phase. The filling cage 91 is composed for example of a coarse-mesh, dimensionally stable network or grid.

If the liquid level 97 rises, the monitoring snorkel 90 abuts against the wall of the filling cage 91 and is submerged by the liquid level 97 of the liquefied gas phase, which rises further. Then, liquefied gas phase emerges via the monitoring snorkel 90 and indicates to the user that the tank has reached its predefined filling level 37.

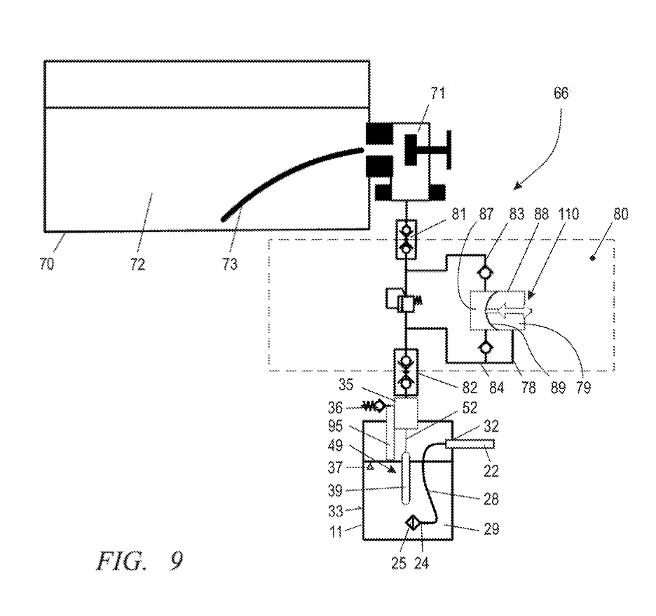

The advantage of the monitoring snorkel 90 consists in that it is connected—via an elastic hose—to the pressure relief valve and thus reliably indicates the attainment of the predefined filling level in every operating situation of the gas tank (FIGS. 7 and 8). The contour of the filling cage 91 shown in FIGS. 6 to 8 is selected such that, when the predefined filling level is reached, irrespective of the situation of the gas tank, a residual volume 98 of the gas tank 11 always remains free from liquefied gas phase.

FIG. 9 shows an assembly 66 for filling a gas tank 11, having a filling device 80 in which a pump 88 is arranged. In the embodiment shown, the pump 88 is in the form of a membrane pump; other pump embodiments may be expedient.

The pump 88 of the filling device 80 as shown in the embodiment as per FIG. 9 has a suction connection 83, which is connected to the gas connection 81 for the supply bottle 70, and a pressure connection 84, which is connected to the fill connection 82 of the filling device 80. Provision is made here for the pressure connection 84 of the pump 88 and the suction connection 83 of the pump 88 to be connected to one another via a pressure equalization valve 86. In this way, unpressurized pumping of the liquefied gas phase is made possible.

The pump chamber 87 of the membrane pump is delimited by a membrane 89 which, driven by a movement drive 110, performs pump strokes. The rear area 79, which is separated from the pump chamber 87, of the pump 88 is expediently connected via a connecting line 78 to the pressure connection 84 of the pump 88. Higher conveying performance can be achieved in this way.

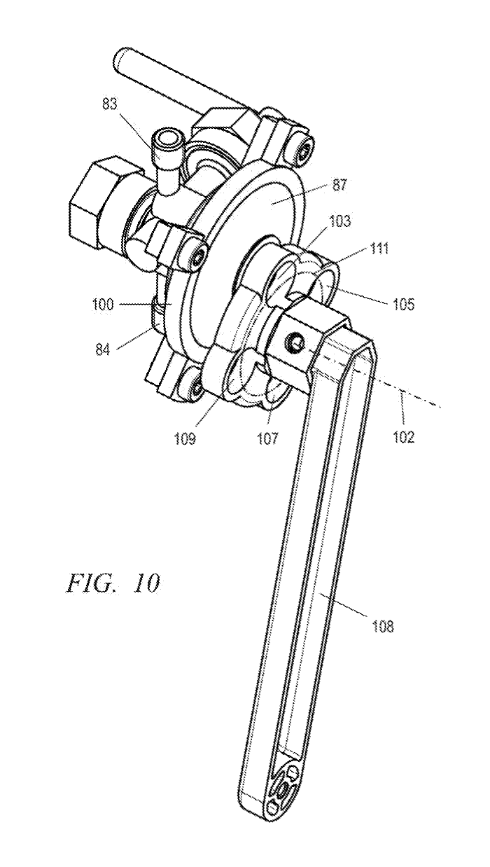

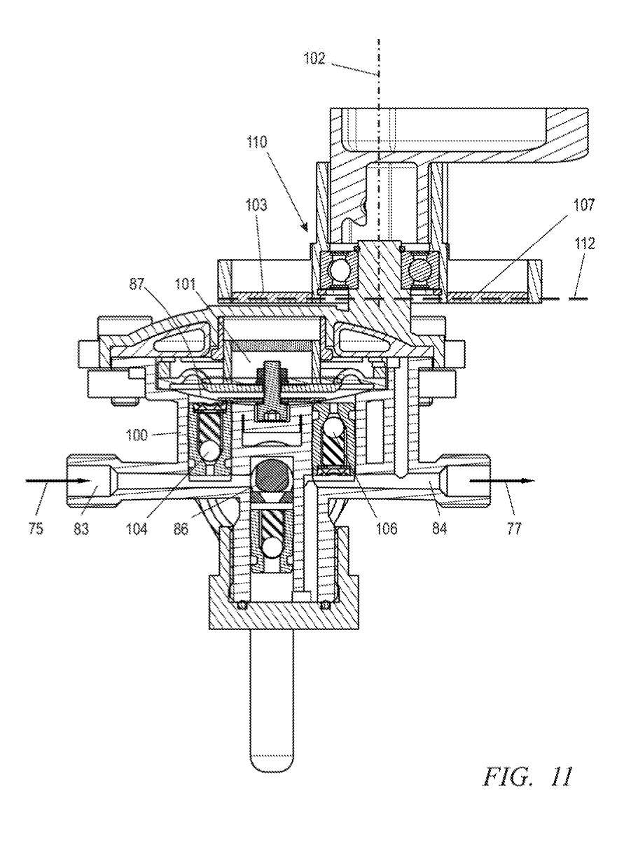

The pump 88 of the filling device 80 expediently has a magnetically driven pump element 101, as shown in FIG. 11. For the movement of the pump element 101, at least one drive magnet 103, 105, 107, 109 is arranged outside the closed pump housing 100. In the embodiment shown, four drive magnets 103, 105, 107 and 109 lie in a drive plane 112 and are provided for being moved relative to the pump element 101 on a circular path 111 (FIG. 10) about a rotary axis 102 via a movement drive 110. It is preferable for drive magnets 103, 105, 107 and 109 which follow one another on the circular path 111 to have alternating polarity, such that, during a rotational movement about the rotary axis 102, the pump element 101 is alternately attracted and repelled. In this way, the liquefied gas flowing in in the arrow direction 75 is sucked via a suction valve 104 into the pump chamber 87 and, via a pressure valve 106, is fed via the pressure connection 84 of the pump housing 100 to the fill valve 35 in the arrow direction 77.

The rotational movement of the movement drive 110 is, in the embodiment of FIGS. 9 and 10, actuated via a hand crank 108. It may be expedient for the movement drive 110 to be provided by an attached battery-powered screwdriver, a drilling machine or the like.

It is understood that the foregoing description is that of the preferred embodiments of the invention and that various changes and modifications may be made thereto without departing from the spirit and scope of the invention as defined in the appended claims.

What is claimed is:

1. An assembly for filling a gas tank for a gas-powered combustion engine, the assembly comprising:
a gas-filled storage bottle;
the gas tank;
a filling device arranged between the gas tank and the storage bottle;
the gas tank having at least one fill valve, a pressure relief valve for gas in the gaseous state, and an extraction valve for liquefied gas;
the filling device having a gas connection for the storage bottle and a fill connection for the fill valve;
the fill valve being connected to the storage bottle via the filling device;
wherein, when the fill valve is open, liquefied gas flows from the storage bottle into the gas tank via the fill valve and, during the inflow of liquefied gas, the pressure relief valve of the gas tank is configured to at least intermittently open; and,
a filling level gauge configured to indicate a predefined filling level of the gas tank.

2. The assembly of claim 1, wherein the filling level gauge is in the form of a float configured to close at least the fill valve when the predefined filling level is reached.

3. The assembly of claim 2, wherein the float is configured to close the fill valve and the pressure relief valve when the predefined filling level is reached.

4. The assembly of claim 1, wherein the filling level gauge is in the form of a monitoring pipe.

5. The assembly as claimed in claim 1 further comprising:
a filling cage defining a cage volume;
the filling level gauge being a monitoring snorkel which floats on the liquid phase of the introduced gas;
the filling cage being arranged in the gas tank;
the gas tank having a predefined filling volume;
the cage volume being smaller than the predefined filling volume of the gas tank; and,
the monitoring snorkel being arranged within the filling cage.

6. The assembly of claim 5, wherein the filling cage is arranged in the gas tank with a spacing on all sides.

7. The assembly of claim 4, wherein the monitoring pipe is connected to the pressure relief valve.

8. The assembly of claim 5, wherein the monitoring snorkel is connected to the pressure relief valve.

9. The assembly of claim 1 further comprising a pressure-relieving pressure reducer connected to the pressure relief valve.

10. The assembly of claim 1, wherein the filling device is equipped with a pump.

11. The assembly of claim 10, wherein the pump is a membrane pump.

12. The assembly of claim 10 further comprising:
a pressure equalization valve;
the pump having a pressure connection and a suction connection; and,
the pressure connection of the pump and the suction connection of the pump being connected to one another via the pressure equalization valve.

13. The assembly of claim 10 further comprising:
a closed pump housing;
at least one drive magnet arranged outside said closed pump housing; and,
the pump having a magnetically driven pump element.

14. The assembly of claim 13 further comprising:
a movement drive; and,
the at least one drive magnet being disposed in a drive plane and being configured to be moved relative to the magnetically driven pump element by the movement drive.

15. The assembly of claim 14, wherein, above the pump element, multiple drive magnets of alternating polarity are movable on a circular path.

16. The assembly of claim 1, wherein the gas tank is mounted on a gas-powered combustion engine having an intake channel; the pressure relief valve has an outlet; and, the outlet of the pressure relief valve opens into the intake channel of the combustion engine.

17. The assembly as claimed in claim 16, wherein the combustion engine is arranged as a drive engine in a handheld work apparatus; and, the gas tank is fixedly mounted on the work apparatus as an operating fluid tank fixed to the apparatus.
